(19) United States
(12) Patent Application Publication
(10) Pub. No.: US 2025/0313272 A1
(43) Pub. Date: Oct. 9, 2025

(54) VEHICLE BODY

(71) Applicants: Shizuma UJU, Nissin-shi Aichi-ken (JP); Norihiko SUZUKI, Toyota-shi Aichi-ken (JP); Akira MISHIMA, Ogaki-shi Gifu-ken (JP)

(72) Inventors: Shizuma UJU, Nissin-shi Aichi-ken (JP); Norihiko SUZUKI, Toyota-shi Aichi-ken (JP); Akira MISHIMA, Ogaki-shi Gifu-ken (JP)

(73) Assignees: TOYOTA JIDOSHA KABUSHIKI KAISHA, Toyota-shi Aichi-ken (JP); PACIFIC INDUSTRIAL CO., LTD., Ogaki Gifu (JP)

(21) Appl. No.: 19/171,937

(22) Filed: Apr. 7, 2025

(30) Foreign Application Priority Data
Apr. 8, 2024 (JP) 2024-061822

(51) Int. Cl. B62D 25/02

(52) U.S. Cl. CPC B62D 25/02

(57) ABSTRACT

A vehicle body is provided which includes a metal body, a quarter panel made of a resin, and a door. The vehicle body further includes a positioning pin provided on the quarter panel, and an insertion hole formed on the metal body and through which the positioning pin is inserted, a lateral gap between the insertion hole and the positioning pin is smaller than a width of a boundary line between the quarter panel and the door, and a vertical gap between the insertion hole and the positioning pin is larger than the lateral gap.

### CROSS REFERENCE TO RELATED APPLICATION

This application claims priority to Japanese Patent Application No. 2024-061822 filed on Apr. 8, 2024, which is incorporated herein by reference in its entirety including the specification, claims, drawings, and abstract.

### TECHNICAL FIELD

The present disclosure relates to a structure of a vehicle body, comprising a metal body, an outer plate made of a resin and attached to the metal body, and an adjacent member attached to the metal body adjacent the outer plate.

### BACKGROUND

JP 2018-144618 A discloses a structure in which a positioning pin is placed, so as to secure precision of a position of a garnish made of a resin in relation to a front fender panel made of a metal.

A component made of a resin has a larger thermal elongation than a metal body. Because of this, when a resin component is to be attached to the metal body, a structure for securing the positional precision such as that disclosed in JP 2018-144618 A is necessary.

Meanwhile, in recent years, vehicle bodies are being considered in which an outer plate made of a resin is attached to a metal body. The resin outer plate has a larger size than the resin garnish described in JP 2018-144618 A, and an absolute amount of the thermal elongation is consequently larger for the resin outer plate than for the garnish. As such, there is a possibility that, due to the thermal elongation, appearance may be degraded, or interference between the outer plate and an adjacent member adjacent the outer plate may occur.

An aspect of the present disclosure lies in suppressing degradation of the appearance and interference with other components due to the thermal elongation of the resin outer plate.

### SUMMARY

According to one aspect of the present disclosure, there is provided a vehicle body comprising: a metal body; an outer plate made of a resin and attached to the metal body; an adjacent member attached to the metal body adjacent the outer plate; a positioning pin provided on one of the metal body and the outer plate; and an insertion hole formed on the other of the metal body and the outer plate and through which the positioning pin is inserted, wherein the positioning pin is placed along a boundary line between the outer plate and the adjacent member, a lateral gap between the insertion hole and the positioning pin, in a direction crossing a direction of extension of the boundary line, is smaller than a width of the boundary line between the outer plate and the adjacent member, and a vertical gap between the insertion hole and the positioning pin, in the direction of extension of the boundary line, is larger than the lateral gap.

With this structure, a movement, due to thermal elongation, of the outer plate made of the resin in a direction crossing the boundary line can be suppressed, and a change of the width of the boundary line with other components can be suppressed. Because of this, degradation of the appearance and interference of the outer plate with the other components due to the change of the width of the boundary line can also be suppressed. Further, because the vertical gap is larger than the lateral gap, the thermal elongation of the outer plate can be absorbed by the vertical gap.

In the vehicle body of the present disclosure, the positioning pin may be provided on the outer plate, and the insertion hole may be formed on the metal body or on a bracket attached to the metal body.

With this structure, the positioning pin can be formed through integral molding of the resin, and the structure can be simplified.

The vehicle body of the present disclosure may further comprise: a clip attached to the outer plate; and a clip insertion hole formed on the metal body and through which the clip is inserted, the clip may be placed along the boundary line between the outer plate and the adjacent member, a lateral clip gap between the clip insertion hole and the clip, in a direction crossing the direction of extension of the boundary line, may be smaller than the width of the boundary line between the outer plate and the adjacent member, and a vertical clip gap between the clip insertion hole and the clip, in the direction of extension of the boundary line, may be larger than the lateral clip gap.

With this structure, a movement, of the outer plate made of the resin, in a direction crossing the boundary line can be effectively suppressed by the clip and the clip insertion hole.

In the vehicle body of the present disclosure, the positioning pin and the clip may be placed alternately along the boundary line.

With this structure, the movement, of the outer plate made of a resin, in a direction crossing the boundary line can be more effectively suppressed.

In the vehicle body of the present disclosure, the outer plate may be a design panel provided on a side of the metal body, the adjacent member may be a door attached to the metal body, the design panel and the door may be placed side by side in a vehicle front-and-rear direction, the lateral gap and the lateral clip gap may be gaps in the vehicle front-and-rear direction, the vertical gap and the vertical clip gap may be gaps in a vehicle up-and-down direction, and the insertion hole and the clip insertion hole may be elongated holes extending in the vehicle up-and-down direction.

With this structure, degradation of the appearance due to a change of a parting width between the design panel and the door can be suppressed, and interference of the design panel with the door, affecting the opening/closing function of the door, can be suppressed.

According to an aspect of the present disclosure, degradation of the appearance and interference with an adjacent member due to thermal elongation of an outer plate made of a resin can be suppressed.

### BRIEF DESCRIPTION OF DRAWINGS

Embodiment(s) of the present disclosure will be described based on the following figures, wherein:

FIG. 1 is a right side view of a vehicle having a vehicle body according to an embodiment of the present disclosure;

FIG. 2 is a right side view of a metal body which is a part of the vehicle body of the embodiment of the present disclosure;

FIG. 3 is an elevation view showing an inner surface of a design panel made of a resin, which is attached to a right side surface of the vehicle according to the embodiment of the present disclosure;

FIG. 4 is a cross-sectional diagram showing a state in which the design panel illustrated in FIG. 3 is attached to the metal body illustrated in FIG. 2, with the upper half showing a cross section along a line A-A of FIG. 2, and the lower half showing a cross section along a line B-B of FIG. 3, with the left and right sides inverted; and

FIG. 5 is a diagram showing a cross section along a line C-C of FIG. 4, and showing an insertion hole provided on a bracket, a clip provided on the metal body, a cross section of a positioning pin inserted through the insertion hole, and a cross section of a shaft portion of a clip inserted through the clip insertion hole.

### DESCRIPTION OF EMBODIMENTS

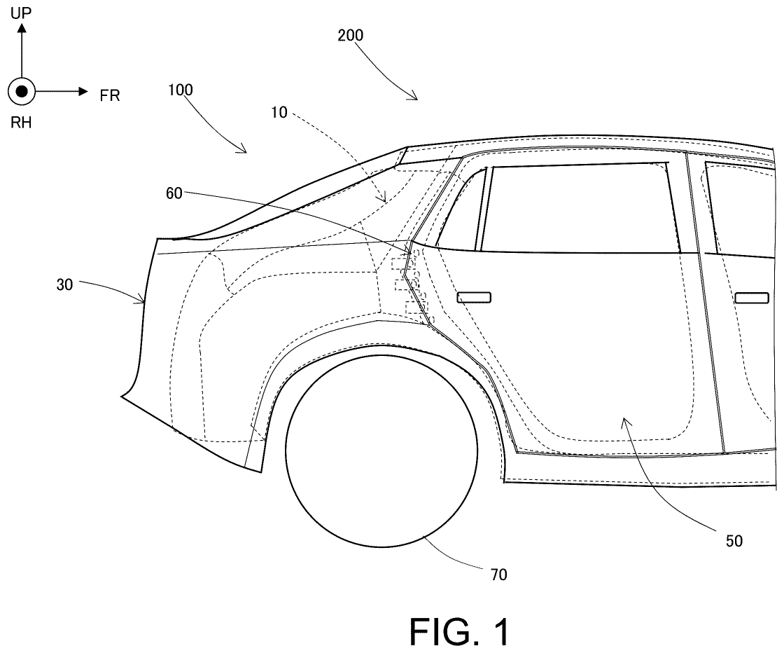

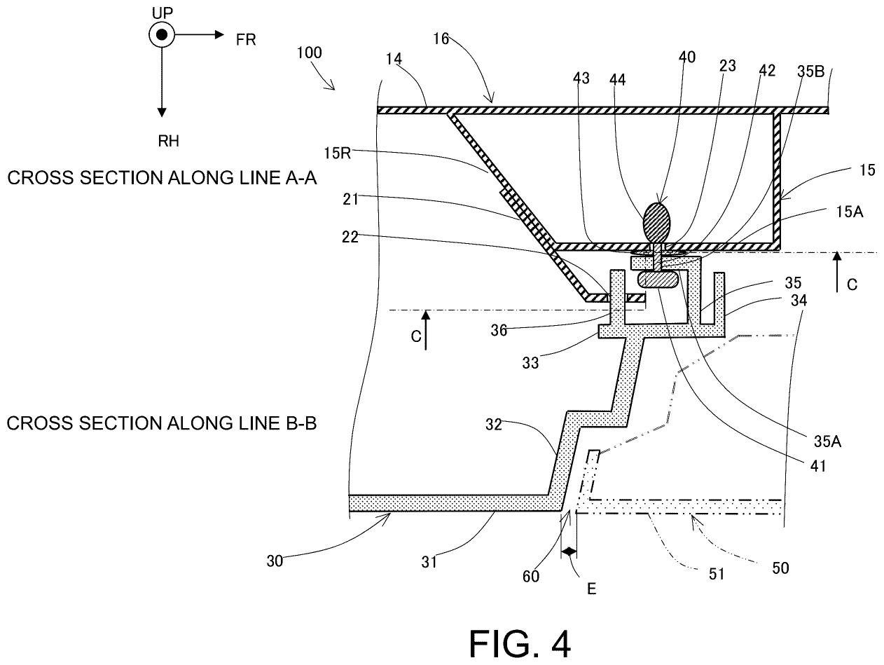

A vehicle body 100 according to an embodiment of the present disclosure will now be described with reference to the drawings. FIG. 1 is a right side view of a vehicle 200 having the vehicle body 100 according to the embodiment of the present disclosure. As shown in FIG. 1, the vehicle 200 has the vehicle body 100 and a rear wheel 70. The vehicle body 100 includes a metal body 10, a quarter panel 30 attached to the metal body 10, and a door 50 attached to the metal body 10, adjacent the quarter panel 30. The quarter panel 30 and the door 50 are separated by a boundary line 60 having a width E (refer to FIG. 4). The quarter panel 30 is an outer plate attached to the metal body 10. The door 50 is an adjacent member adjacent the quarter panel 30. “FR”, “UP”, and “RH” in the drawings refer respectively to a front side, an upper side, and a right side of the vehicle 200. In addition, directions opposite from FR, UP, and RH are respectively a rear side, a lower side, and a left side. In the following, when a description is made simply by reference to the directions of front/rear, left/right, and upper/lower, these directions refer to the front and rear, the left and right, and the upper side and lower side of the vehicle 200, respectively, unless otherwise indicated. The front/rear, left/right, and upper/lower directions of the vehicle 200 are coincident with the front/rear, left/right, and upper/lower directions of the vehicle body 100.

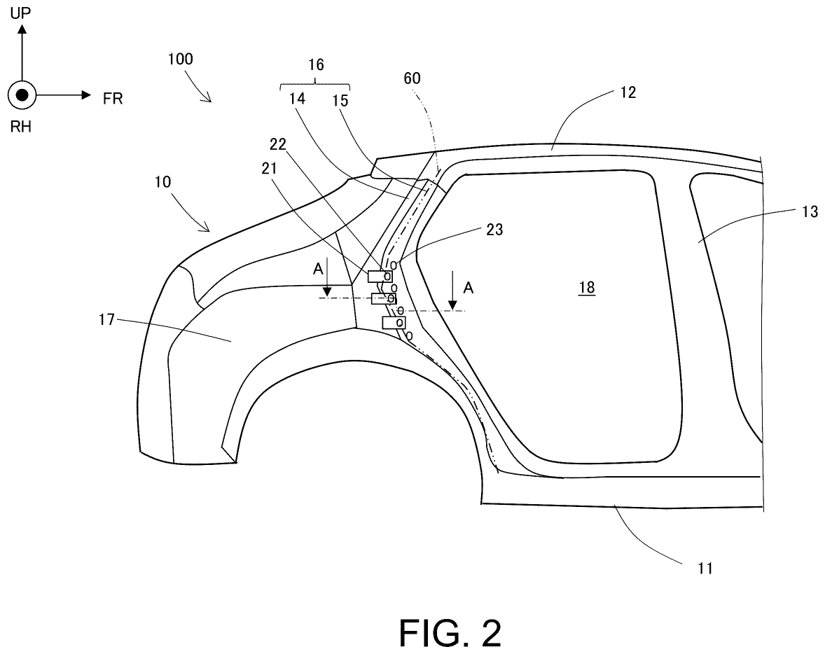

As shown in FIG. 2, the metal body 10 comprises a rocker 11, a roof rail 12, a center pillar 13, a rear pillar 16, and a rear side panel 17. The metal body 10 is made of a metal.

The rocker 11 is a skeleton member placed at a lower part of the vehicle body 100, and extending in a vehicle front-and-rear direction. The roof rail 12 is a skeleton member placed at an upper part of the vehicle body 100, and extending in the vehicle front-and-rear direction. The center pillar 13 is a skeleton member which connects the rocker 11 and the roof rail 12 in an up-and-down direction, at a center of the vehicle body 100 in the front-and-rear direction. The rear pillar 16 connects the rocker 11 and the roof rail 12 in the up-and-down direction at a rear part of the vehicle body 100. The rear pillar 16 is a skeleton member having a closed cross section, formed from an inner panel 14 of a plate shape, and an outer panel 15 which is a member with a groove shape cross section (refer to FIG. 4). The rear side panel 17 forms a side part at a rear part of the metal body 10, at a rear side in relation to the rear pillar 16. The rocker 11, the roof rail 12, the center pillar 13, and the rear pillar 16 define a door opening 18.

As shown in FIG. 2, at a center part of the outer panel 15 in the up-and-down direction, four clip insertion holes 23 are formed. The clip insertion hole 23 is an elongated hole extending in the vehicle up-and-down direction. A shaft portion 42 of a clip 40 to be described later is inserted through the clip insertion hole 23. In addition, at the center part of the outer panel 15 in the up-and-down direction, three brackets 21 are attached. As shown in FIG. 4, the bracket 21 is a plate member which is attached to a rear flange 15R of the outer panel 15, which extends in a vehicle front-right direction, and which has a front end which is bent in parallel with a bottom plate 15A of the outer panel 15. An insertion hole 22 is formed at the front end of the bracket 21. The insertion hole 22 is an elongated hole extending in the vehicle up-and-down direction. A positioning pin 36 of the quarter panel 30 to be described later is inserted through the insertion hole 22. As shown in FIG. 2, the bracket 21 is attached to the outer panel 15 in such a manner that the clip insertion holes 23 and the insertion holes 22 are placed alternately in the up-and-down direction.

On the rear side panel 17 of the metal body 10, a plurality of clip insertion holes 23 are formed in addition to the four clip insertion holes 23 described above with reference to FIG. 2, but illustration of these other clip insertion holes 23 is omitted.

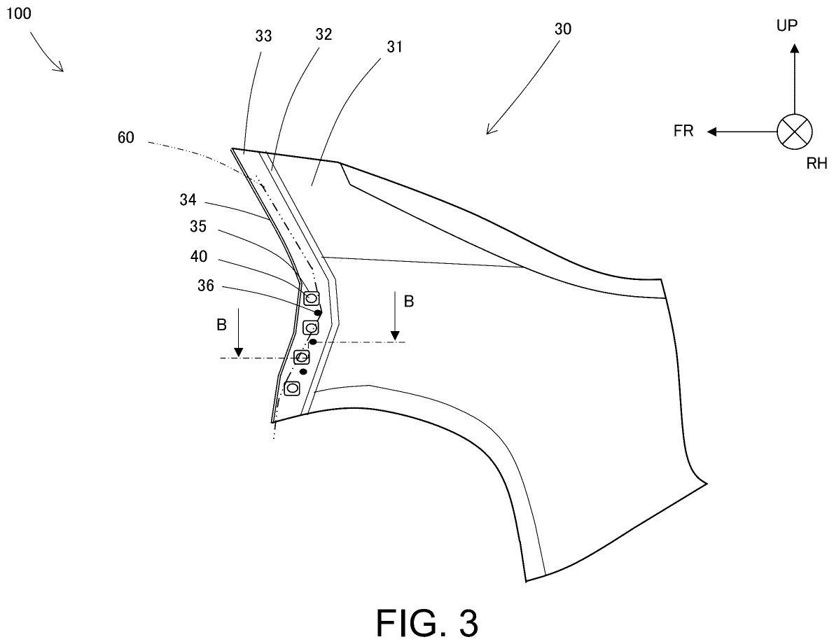

FIG. 3 shows an inner surface of the quarter panel 30 attached on an outer side of the rear side panel 17. The quarter panel 30 is a design panel made of a resin, having an outer surface forming a design surface of the side of the vehicle body 100. As shown in FIG. 3, the quarter panel 30 includes a body 31, a step 32, an attachment base 33, an end plate 34, a clip pedestal 35, and the positioning pin 36. The body 31, the step 32, the attachment base 33, the end plate 34, the clip pedestal 35, and the positioning pin 36 are formed through integral molding of a resin.

As shown in FIG. 4, the body 34 covers the outer side of the rear side panel, and has an outer surface forming the design surface of the side of the vehicle body 100. The step 32 is a stair-shaped portion provided at a front part of the body 31, and which extends from the body 31 toward an inner side of the vehicle. The attachment base 33 is a plate member connected to a vehicle inner side end of the step 32. As shown in FIG. 3, the attachment base 33 is curved, to be convex toward the rear side of the vehicle, so as to oppose the bottom plate 15A of the outer panel 15. The end plate 34 is provided in a standing manner from the attachment base 33 toward the vehicle inner side. Referring again to FIG. 4, the end plate 34 is placed to extend from the attachment base 33 toward the bottom plate 15A of the outer panel 15, and subsequently to the door opening 18. The clip pedestal 35 is a member with an L-shape cross section, protruding from the attachment base 33 toward the vehicle inner side. On an inner flange 35A at the vehicle inner side, a clip attachment hole 35B is formed. The clip 40 is attached to the clip attachment hole 35B. The positioning pin 36 is a circular bar member which protrudes from the attachment base 33 toward the vehicle inner side. As shown in FIG. 3, the clip pedestal 35 and the positioning pin 36 are placed alternately in the vehicle up-and-down direction.

As shown in FIG. 4, the clip 40 has a head 41, the shaft portion 42, a fixation ring 43, and an engagement portion 44. The shaft portion 42 of the clip 40 is inserted from an outer side of the inner flange 35A into the clip attachment hole 35B. The fixation ring 43 is fitted to the shaft portion 42 protruding toward an inner side of the inner flange 35A. The fixation ring 43 and the head 41 sandwich the inner flange 35A from respective sides, so as to fix the clip 40 on the inner flange 35A.

As shown in FIG. 3, the quarter panel 30 in which the clip 40 is fixed on the clip pedestal 35 is inverted, the engagement portion 44 of the clip 40 is pressed into the clip insertion hole 23 shown in FIG. 2, and the positioning pin 36 is inserted through the insertion hole 22 of the bracket 21. As shown in FIG. 4, when the engagement portion 44 is caused to protrude toward the inner side of the inner flange 35A, the engagement portion 44 opens, and is engaged on the inner surface of the inner flange 35A. With this process, the quarter panel 30 is attached to the outer side of the rear side panel 17. When the quarter panel 30 is attached to the rear side panel 17, the positioning pin 36 is inserted through the insertion hole 22.

As shown in FIG. 4, when the door 50 is attached to the metal body 10, the gap having the width E is formed on a boundary line 60 between a front end of the body 31 of the quarter panel 30 and a rear end of a resin panel 51 of the door 50.

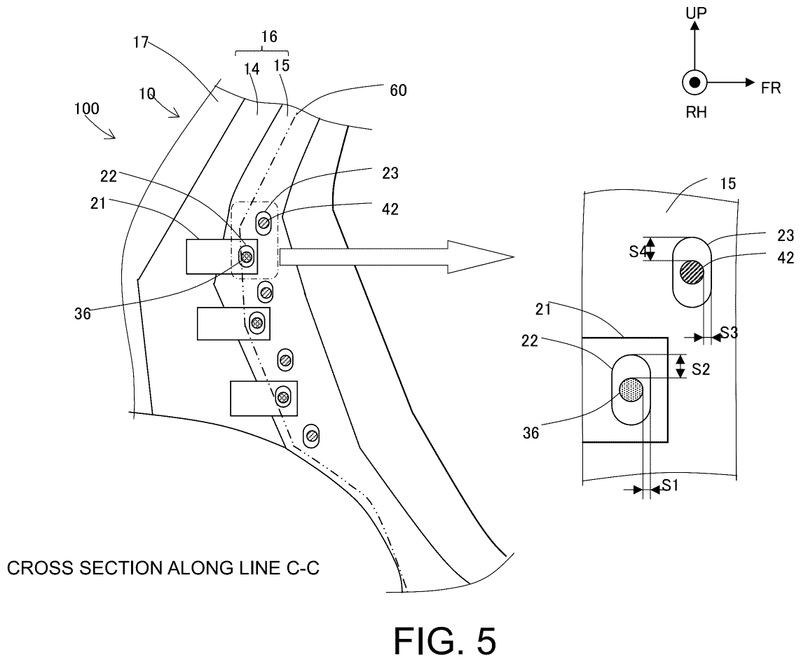

As shown in FIG. 5, the insertion hole 22 and the clip insertion hole 23 are elongated holes extending in the vehicle up-and-down direction. A gap is present between the positioning pin 36 and the insertion hole 22. A lateral gap S1 between the positioning pin 36 and the insertion hole 22 in the vehicle front-and-rear direction is smaller than the width E of the boundary line 60. In addition, a vertical gap S2 between the positioning pin 36 and the insertion hole 22 in the vehicle up-and-down direction is larger than the lateral gap S1. Similarly, a gap is present between the shaft portion 42 of the clip 40 and the clip insertion hole 23, a lateral clip gap S3 between the shaft portion 42 and the clip insertion hole 23 in the vehicle front-and-rear direction is smaller than the width E of the boundary line 60, and a vertical clip gap S4 between the shaft portion 42 and the clip insertion hole 23 in the vehicle up-and-down direction is larger than the lateral clip gap S3. Here, the lateral gap S1 and the lateral clip gap S3 are gaps in a direction crossing the boundary line 60, and the vertical gap S2 and the vertical clip gap S4 are gaps in a direction of extension of the boundary line 60.

When a temperature of the vehicle body 100 having the structure described above rises, the quarter panel 30 made of the resin thermally expands in a greater extent than the metal body 10. In this process, the insertion hole 22 and the clip insertion hole 23, which are elongated holes extending in the up-and-down direction, permit movement, due to the thermal expansion, of the positioning pin 36 and the shaft portion 42 of the clip 40, in the up-and-down direction with respect to the metal body 10. With this configuration, the thermal elongation of the quarter panel 30 made of the resin can be absorbed. On the other hand, the insertion hole 22 and the clip insertion hole 23 restrict the amount of movement of the positioning pin 36 and the shaft portion 42 in the vehicle front-and-rear direction to an amount smaller than the width E of the gap of the boundary line 60. Because of this, movement of the quarter panel 30 toward the resin panel 51 of the door 50, and consequent interference of the quarter panel 30 with the resin panel 51 can be suppressed. In addition, degradation of appearance of the vehicle 200, caused by a significant change of the width E of the gap of the boundary line 60, due to the movement of the quarter panel 30 toward the resin panel 51 of the door 50, can be suppressed.

Furthermore, because the body 31, the step 32, the attachment base 33, the end plate 34, the clip pedestal 35, and the positioning pin 36 are formed through integral molding of the resin, the interference of the quarter panel 30 with the resin panel 51 can be suppressed with a simple structure.

Moreover, with the insertion holes 22 and the clip insertion holes 23, and the positioning pins 36 and the clips 40, which are placed alternatively in the vehicle up-and-down direction, the change of the width E of the boundary line 60 between the quarter panel 30 and the door 50 can be effectively suppressed. With this configuration, a change of the appearance of the vehicle body 100 due to the change of the width E of the boundary line 60 can be effectively suppressed.

In the above, a configuration is described in which the bracket 21 is attached to the outer panel 15 in such a manner than the clip insertion hole 23 and the insertion hole 22 are placed alternately in the up-and-down direction, and the clip pedestal 35 and the positioning pin 36 are placed alternately in the vehicle up-and-down direction, but the present disclosure is not limited to such a configuration. For example, the bracket 21 may be attached to the outer panel 15 in such a manner that the clip insertion hole 23 and the insertion hole 22 are placed alternately along the boundary line 60, and the clip pedestal 35 and the positioning pin 36 may be placed alternately along the boundary line 60. The clip insertion hole 23 and the insertion hole 22 may be elongated holes which are elongated in a direction which is inclined in relation to the up-and-down direction, which is the direction of extension of the boundary line 60. In this configuration, the lateral gap S1 and the lateral clip gap S3 may be configured to be gaps in a direction orthogonal to the boundary line 60 and to be smaller than the width E of the boundary line 60. Further, the vertical gap S2 and the vertical clip gap S4 may be configured to be gaps in a direction inclined in relation to the up-and-down direction, which is the direction of extension of the boundary line 60, and to be larger than the lateral gap S1 and the lateral clip gap S3, respectively.

In addition, in the above, a configuration is described in which the positioning pin 36 is provided on the quarter panel 30, and the insertion hole 22 is formed on the bracket 21 attached to the rear pillar 16, but the present disclosure is not limited to such a configuration. For example, the insertion hole 22 may be formed on the outer panel 15 of the rear pillar 16. Further, a configuration may be employed in which the positioning pin 36 is attached to the bracket 21 of the rear pillar 16, and the insertion hole 22 is formed on the attachment base 33 of the quarter panel 30. Alternatively, the positioning pin 36 may be attached to the outer panel 15 of the rear pillar 16, and the insertion hole 22 may be formed on the attachment base 33 of the quarter panel 30.

In addition, in the above, a configuration is described in which, in the vehicle body 100 of the embodiment, the quarter panel 30 is attached to the metal body 10 with the insertion hole 22 and the positioning pin 36, and the clip insertion hole 23 and the clip 40, so as to suppress the interference of the quarter panel 30 with the door 50, and to suppress the change of the width E of the boundary line 60, but the present disclosure is not limited to such a configuration. For example, a configuration may be employed in which the insertion hole 22 and the clip insertion hole 23 are formed along a boundary line between a fender panel, which is made of a resin and which covers a fender made of a metal and positioned at a front part of the vehicle, and a front door, so as to suppress interference of the fender panel with the front door, and to suppress a change of a width of the boundary line. As another example configuration, the insertion hole 22 and the clip insertion hole 23 may be formed along a boundary line between the resin fender panel covering the metal fender at the front part of the vehicle and a hood made of a resin, so as to suppress interference of the fender panel with the hood, and to suppress a change of a width of the boundary line. In this case, the boundary line extends in the vehicle front-and-rear direction, the lateral gap S1 and the lateral clip gap S3 are gaps in a vehicle width direction, and the vertical gap S2 and the vertical clip gap S4 are gaps in the vehicle front-and-rear direction. Furthermore, as another example configuration, the insertion hole 22 and the clip insertion hole 23 may be formed along a boundary line between a roof side panel covering an outer surface of the roof rail 12 made of a metal, and a resin roof panel which is a part of the roof, so as to suppress interference of the roof side panel with the resin roof panel, and to suppress a change of a width of the boundary line. In this case, the boundary line extends in the vehicle front-and-rear direction, the lateral gap S1 and the lateral clip gap S3 are gaps in the vehicle width direction, and the vertical gap S2 and the vertical clip gap S4 are gaps in the vehicle front-and-rear direction.

1. A vehicle body comprising:
a metal body;
an outer plate made of a resin and attached to the metal body;
an adjacent member attached to the metal body adjacent the outer plate;
a positioning pin provided on one of the metal body and the outer plate; and
an insertion hole formed on the other of the metal body and the outer plate, and through which the positioning pin is inserted, wherein
the positioning pin is placed along a boundary line between the outer plate and the adjacent member,
a lateral gap between the insertion hole and the positioning pin, in a direction crossing a direction of extension of the boundary line, is smaller than a width of the boundary line between the outer plate and the adjacent member, and
a vertical gap between the insertion hole and the positioning pin, in the direction of extension of the boundary line, is larger than the lateral gap.

2. The vehicle body according to claim 1, wherein
the positioning pin is provided on the outer plate, and
the insertion hole is formed on the metal body or on a bracket attached to the metal body.

3. The vehicle body according to claim 2, further comprising:
a clip attached to the outer plate; and
a clip insertion hole formed on the metal body and through which the clip is inserted, wherein
the clip is placed along the boundary line between the outer plate and the adjacent member,
a lateral clip gap between the clip insertion hole and the clip, in a direction crossing the direction of extension of the boundary line, is smaller than the width of the boundary line between the outer plate and the adjacent member, and
a vertical clip gap between the clip insertion hole and the clip, in the direction of extension of the boundary line, is larger than the lateral clip gap.

4. The vehicle body according to claim 3, wherein
the positioning pin and the clip are placed alternately along the boundary line.

5. The vehicle body according to claim 3, wherein
the outer plate is a design panel provided on a side of the metal body,
the adjacent member is a door attached to the metal body,
the design panel and the door are placed side by side in a vehicle front-and-rear direction,
the lateral gap and the lateral clip gap are gaps in the vehicle front-and-rear direction,
the vertical gap and the vertical clip gap are gaps in a vehicle up-and-down direction, and
the insertion hole and the clip insertion hole are elongated holes extending in the vehicle up-and-down direction.

6. The vehicle body according to claim 4, wherein
the outer plate is a design panel provided on a side of the metal body,
the adjacent member is a door attached to the metal body,
the design panel and the door are placed side by side in a vehicle front-and-rear direction,
the lateral gap and the lateral clip gap are gaps in the vehicle front-and-rear direction,
the vertical gap and the vertical clip gap are gaps in a vehicle up-and-down direction, and
the insertion hole and the clip insertion hole are elongated holes extending in the vehicle up-and-down direction.
